(19) United States
(12) Patent Application Publication
(10) Pub. No.: US 2004/0053018 A1
(43) Pub. Date: Mar. 18, 2004

(54) Applique

(76) Inventors: Junko Morofushi, Narashino-shi (JP); Seiki Tsukamoto, Tokorozawa-shi (JP)

Correspondence Address: Curt Harrington, Suite 250, 6300 State University Drive, Long Beach, CA, 90815, US

(21) Appl. No.: 10/243,719

(22) Filed: Sep. 12, 2002

(51) Int. Cl. B32B 3/00; B32B 27/14

(52) U.S. Cl. 428/196

(57) ABSTRACT

The present invention relates to an applique, and its object is to provide an applique that everyone can create easily original handmade applique having a three-dimensional effect and rich in splendor and novelty. It is an applique which is attached on obverse side of cloth and paper etc., wherein after a process for creating plural color patching by cutting in arbitrary form a color sheet which has an adhesive layer on reverse side, subsequently, a transparent or translucent temporary tack plate is superposed on upper surface of an original drawing of picture, and a picture pattern is created by sticking the color patching to the obverse side of the temporary tack plate in accordance with the original drawing of picture, then the applique is obtained through a process which exfoliates the picture pattern from the obverse side of the temporary tack plate, and these processes for creating applique are repeated if necessary to create plural picture patterns, and the plural picture patterns are combined to obtain the applique, and the applique is carried out thermo compression bonding on the obverse side of cloth and paper etc.

### BACKGROUND OF THE INVENTION

1. Field of the Invention

The present invention relates to an applique, and its object is to provide an applique that everyone can create easily original handmade applique having a three-dimensional effect and rich in splendor and novelty.

2. Description of the Related Art

Conventionally, as a method of adhesion of picture to cloth, paper, etc., for example, an applique ornament and an embroidery ornament are used for the ornament of cloth or clothes, and for ornament of paper or wallpaper, cut picture or pasted picture are used.

In these ornaments, the applique ornament is to sew an ornament cloth on a base cloth, such as cloth, race, and leather, and the applique which has an emblem shape of the applique which is shape of flower, animal, a character or a pattern is on shelves. The applique of heat adhesion is applied ardity adhesives previously on reverse side of these materials, and the ardity adhesive is gotten soft with heating devise such as a home use iron, and the material is adhered on the cloth by pressuring. Moreover, a sheet material which is applied the ardity adhesives on reverse side of a nylon system fiber or a rubber system material with objective character or the form of a design is cut for team names such as baseball, soccer, and basketball team, and sport mark such as a uniform number, and these characters and forms are adhered on a uniform, a shirt, etc. with a business-use heat press machine.

However, the applique ornament using a commercial item which is sold with above-mentioned ready-made shape is planar and without three dimensional effect in its finish, and the applique ornament has disadvantage that it is apt to exfoliate by washing. Moreover, it has the fault that a design has uniformity and becomes monotonous.

### BRIEF SUMMARY OF THE INVENTION

The present invention is invented to solve above-mentioned problems, and its purpose is to provide the applique which everyone can create easily original handmade applique having a three-dimensional effect and rich in splendor and novelty by disposing, connecting, bending and superposing a cloth in longitudinal, transversal and crosswise.

The present invention described in claim 1 is an applique which is attached on obverse side of cloth and paper etc. wherein after a process for creating plural color patching by cutting in arbitrary form a color sheet which has an adhesive layer on reverse side, subsequently, a transparent or translucent temporary tack plate is superposed on upper surface of an original drawing of picture, and a picture pattern is created by sticking the color patching to the obverse side of the temporary tack plate in accordance with the original drawing of picture, then the applique is obtained through a process which exfoliates the picture pattern from the obverse side of the temporary tack plate, and these processes for creating applique are repeated if necessary to create plural picture patterns, and the plural picture patterns are combined to obtain an applique, and the applique is carried out thermo compression bonding on the obverse side of cloth and paper etc.

The present invention described in claim 2 is an applique described in claim 1, wherein in said process for creating a picture pattern, previously created picture pattern is arranged between said original drawing of picture and said temporary tack plate, and a following picture pattern is created according to said previously created picture pattern.

The present invention described in claim 3 is an applique described in claim 1, wherein said color patching is strip-shaped, round and polygonal color patching, and in creating a picture pattern, a three-dimensional effect is brought by connecting, bending, disposing and overlapping said color patching.

The present invention described in claim 4 is an applique described in claim 2, wherein said color patching is strip-shaped, round, and in creating a picture pattern, polygonal color patching, a three-dimensional effect is brought by connecting, bending, disposing and overlapping said color patching.

The present invention described in claim 5 is an applique described in claim 1, wherein said color patching is used more than two colors.

The present invention described in claim 6 is an applique described in claim 2, wherein said color patching is used more than two colors.

The present invention described in claim 7 is an applique described in claim 3, wherein said color patching is used more than two colors.

The present invention described in claim 8 is an applique described in claim 4 wherein said color patching is used more than two colors.

The present invention described in claim 9 is an applique described in claim 3 wherein excessive cloth is cut off from the reverse side of the applique at the overlapped part of said color patching.

The present invention described in claim 10 is an applique described in claim 4 wherein excessive cloth is cut off from the reverse side of the applique at the overlapped part of said color patching.

The present invention described in claim 11 is an applique described in claim 5 wherein the excessive cloth is cut off from the reverse side of the applique at the overlapped part of said color patching.

The present invention described in claim 12 is an applique described in claim 6 wherein the excessive cloth is cut off from the reverse side of the applique at the overlapped part of said color patching.

The present invention described in claim 13 is an applique described in claim 7 wherein the excessive cloth is cut off from the reverse side of the applique at the overlapped part of said color patching.

The present invention described in claim 14 is an applique described in claim 8 wherein the excessive cloth is cut off from the reverse side of the applique at the overlapped part of said color patching.

### BRIEF EXPLANATION OF THE DRAWINGS

Hereinafter, preferred embodiments of the present invention are explained with referring to the drawings.

FIG. 1 is a front view showing an example which carries out the applique relating to the present invention on clothes.

FIG. 2 is a perspective view of the color patching which is cut from the color sheet.

FIG. 3 is a plan view of the original drawing of picture.

FIG. 4 is a plan view of the state where the temporary tack plate is put on the upper surface of the original drawing of picture.

FIG. 5 is a plan view where the color patching is stuck on the surface of the temporary tack plate on the original drawing of picture.

FIG. 6 is a sectional view according to A-A line in FIG. 5.

FIG. 7 is a plan view where the color patching is stuck on the surface of the temporary tack plate on the original drawing of picture.

FIG. 8 is a sectional view according to B-B line in FIG. 7.

FIG. 9 is a plan view where the pattern of picture is put on and stuck to the temporary tack plate.

FIG. 10

(a) is a plan view from the rear side showing a part where three color patching are overlapped.

(b) is a sectional view according to C-C line in (a).

(c) is a sectional view where the color patching located in the bottom among (b) is cut off.

(d) is a sectional view where the color patching processed by (c) is adhered to cloth.

### DESCRIPTION OF THE PREFERRED EMBODIMENTS OF THE INVENTION

The creation of the applique which relates to the present invention needs to prepare an original drawing of picture (2), a transparent or translucent temporary tack plate (1) through which the original drawing of picture (2) is seen, and a color sheet which has adhesive layer on reverse side. The original drawing of picture (2) is an original picture which is used for the applique, and for example, the original picture is a sketch which was drawn by looking actual pictures or photographs of characters and animals and plants, etc. A color patching (3) which is cut up a color sheet is in accordance with color of the original picture.

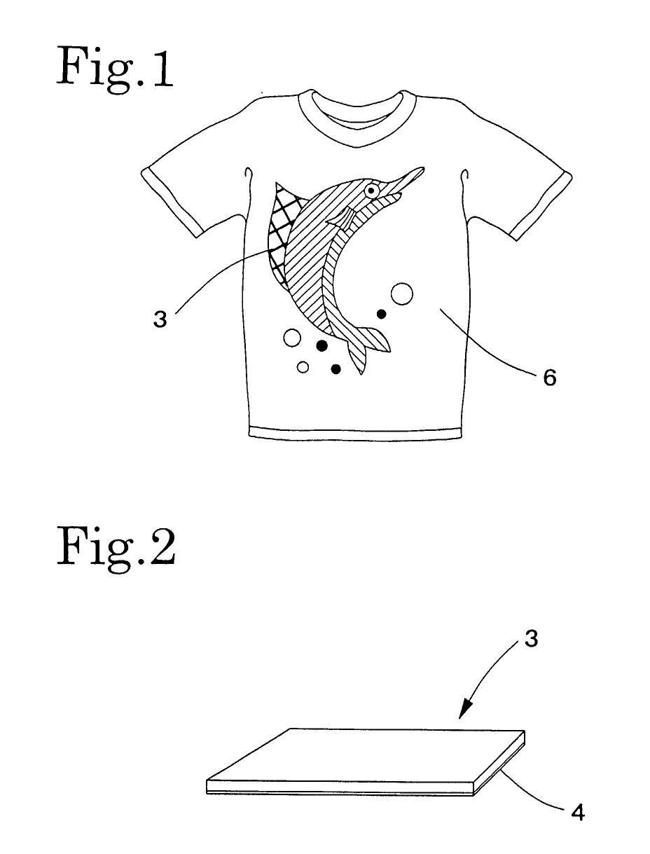

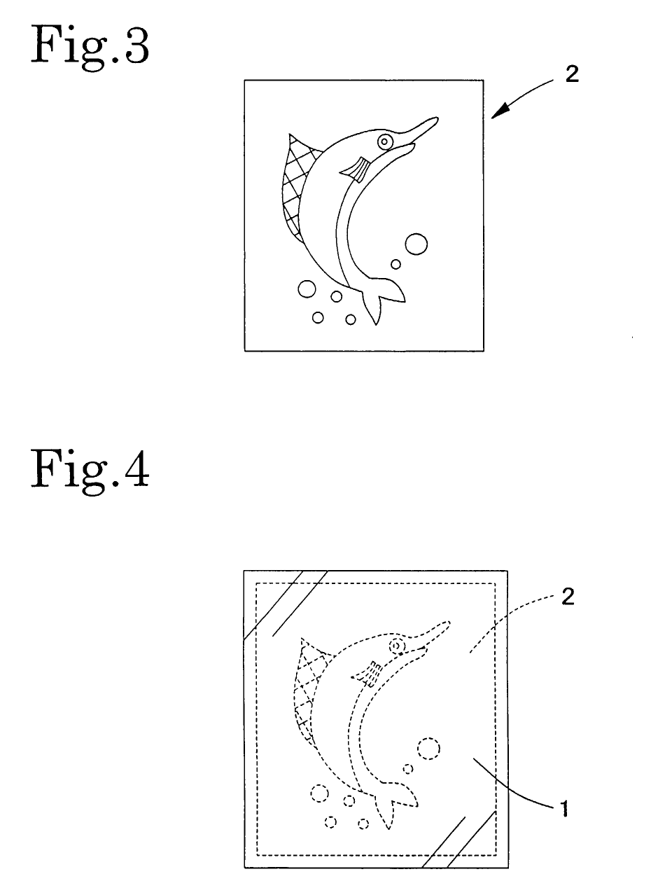

The applique which is created by the color patching (3) in accordance with the original drawing of picture (2) is attached to clothes, cloth and paper, etc. as shown in FIG. 1.

To create the applique which relates to the present invention, as first process, a color sheet which has an adhesive layer (4) on the reverse side is cut up in arbitrary shape, for example such as strip-shaped, round, polygonal and star, and plural color patching (3) as shown in FIG. 2 are created.

A color sheet used in the present invention has the ardity adhesive layer (4) on the reverse side. The adhesive layer (4) has a feature that it gets soft with heating, and it becomes rigid when it is cooled down. Therefore, the color sheet gets soft with heating, and it can be bend, and when it is cooled down, it holds its shape. A color is selected in accordance with the original picture of applique which is created, and the color sheet of red, blue, yellow, black, green, and other required colors is prepared.

Next, as second process, the transparent or translucent temporary tack plate (1) is overlapped on the original drawing of picture (2), and a pattern of picture is created by sticking the color patching (3) prepared in the first process in accordance with the original drawing of picture (2) on the obverse side of the temporary tack plate (1).

As mentioned above, the temporary tack plate (1) used in the present invention is used a transparent or translucent plate so that the original drawing of picture (2) which is located under the temporary tack plate (1) is seen thorough the temporary tack plate (1) as shown in FIG. 4. The temporary tack plate (1) is not restricted particularly, it is desirable to use a transparent plastic plate which has glass or heat resistant obverse side so that in order to paste the color patching (3) with using heating device. Moreover, the smooth obverse side without unevenness is desirable, and dust, dirt etc. on the obverse side is wiped away with cloth etc. beforehand.

After said temporary tack plate (1) is superposed on upper surface of the original drawing of picture (2), the color patching (3) is carried out temporary compression bonding on surface of the temporary tack plate (1) in accordance with colors of the original drawing of picture (2). The color patching (3) is arranged in accordance with the original drawing of picture (2) so that the adhesive layer (4) of the color patching (3) touches obverse side of the tack plate (1), and obverse side of the color patching (3) is carried out temporary compression bonding by pressing by the heating device. As the heating device, for example, flatiron or iron is used. In case of using the flatiron, the temperature of the heating device is desirable temperature which is generated with 100V, 8W-10W. When the heating device is slid horizontally, it causes enlarging of the color patching (3), hence the color patching (3) should be moved up and down to carry out compression bonding.

Further, an overlapping part of each color patching (3) is carried out compression bonding with overlapping so that the basic color patching (3) comes out to the obverse side, and it is cut off lower cloth so that it does not come out from the obverse side cloth as shown in FIG. 6. In case of using the applique for clothes, if the plural color patching (3) overlap, adhesive strength declines, and overlapped part gets stiff, hence, connecting part and overlapping way are considered not to make the color patching (3) overlapped more than double if possible. In case of cutting the cloth, in order to prevent the color patching (3) from shifting from the original drawing of picture (2), a scissor is used in the position near glass.

Next, the created pattern of picture is exfoliated from the temporary tack plate (1).

As a pretreatment of exfoliation, a sheet is put on the part where the color patching (3) is overlapped, and it is stuck by thermo compression bonding with the heating device applied on the sheet. This sheet is not particularly limited if only it bears the temperature of the heating device, and the color patching (3) under the sheet is seen through, and it does not adhere to the color patching (3), and for example, Teflon sheet, silicone paper, etc. can be cited. Additionally, it is better for a part which has the cut end of this color patching (3) in obverse side to be processed by processing flatiron etc. for prevention of fray. Then, it is exfoliated slowly from the temporary tack plate (1) using sharp-pointed tool, such as a bamboo skewer.

Thus, the applique which relates to the present invention is completed, and the applique can be arranged on the subject surfaces, such as clothes, cloth, and paper etc., and stuck by thermo compression bonding, and united with them.

Moreover, the applique in the present invention may repeat the first process and the second process of the above for creating plurality of patterns of picture, and thus creating three-dimensional and new applique.

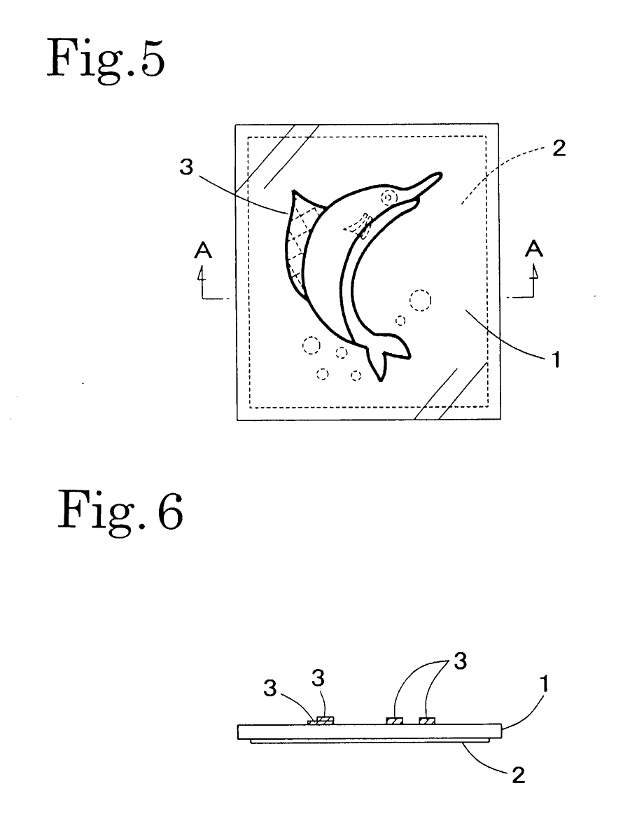

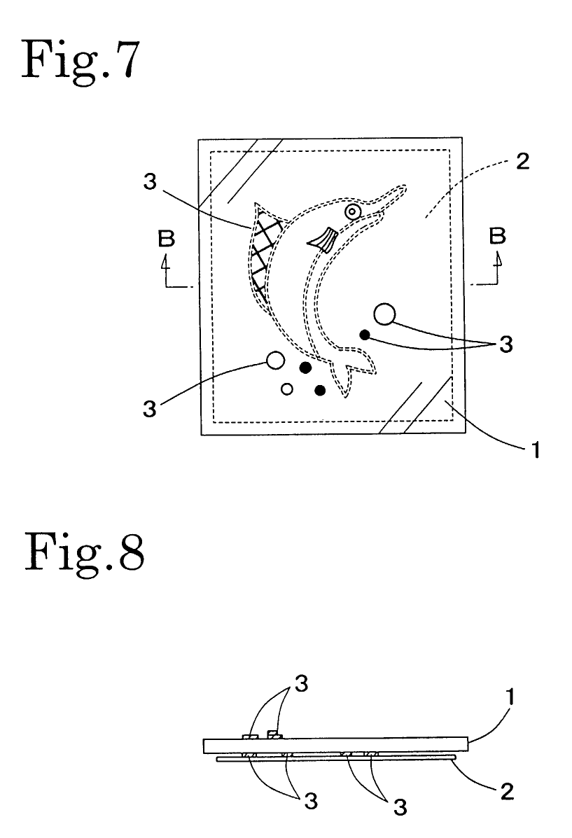

For example, the pattern of picture with an outline as shown in FIG. 5, and the pattern of picture with a design part as shown in FIG. 7 is created separately, then they are combined at the last by sticking the overlapped part by compression bonding to complete the applique. A three-dimensional effect is brought by combining plurality of patterns of picture to create the applique.

In this case, as shown in FIGS. 7 and 8, the pattern of picture created previously is arranged between the original drawing of picture (2) and the temporary tack plate (1), and the pattern of other design parts is created according to this pattern of picture. By this method, when all the patterns are superposed, no error in size is occurred and excessive cloth does not run off at the superposed part.

The applique is completed by combining plurality of created patterns of picture, and as stated previously, it is arranged on the subject surfaces, such as clothes, cloth, and paper etc. and stuck by compression bonding, and united with them.

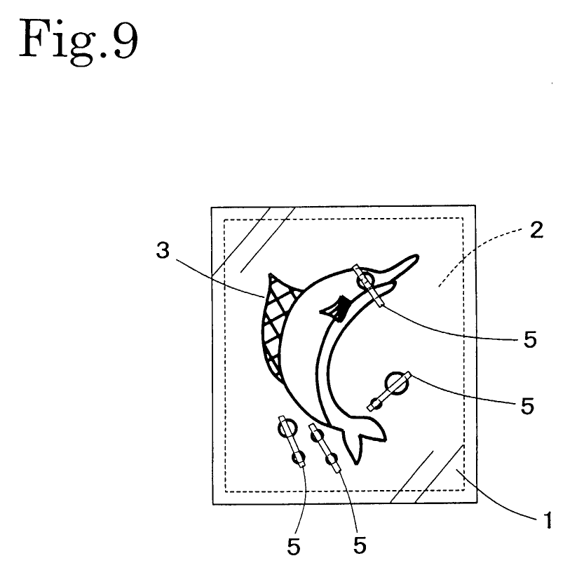

When plurality of patterns of picture created separately are combined, as shown in FIG. 9, the temporary tack plate (1) is put on the upper surface of the original drawing of picture (2), and the pattern of picture created according to this original drawing of picture (2) respectively is put on it and laid out. On the above mentioned sheet, the heating device is applied and the part where each pattern of picture is overlapped is stuck by thermo compression bonding. As shown in FIG. 9, the pattern created independently like fish eyes or bubbles in the original drawing which was used for explanation of the applique creation method of the present invention, is fixed with the pattern of picture of main part and the adjoining pattern by using the temporary tack tape (5) which can be ironed, then it is removed from the temporary tack plate (1). By using the temporary tack tape (5), an applique of completely same pattern as the original drawing of picture can be created.

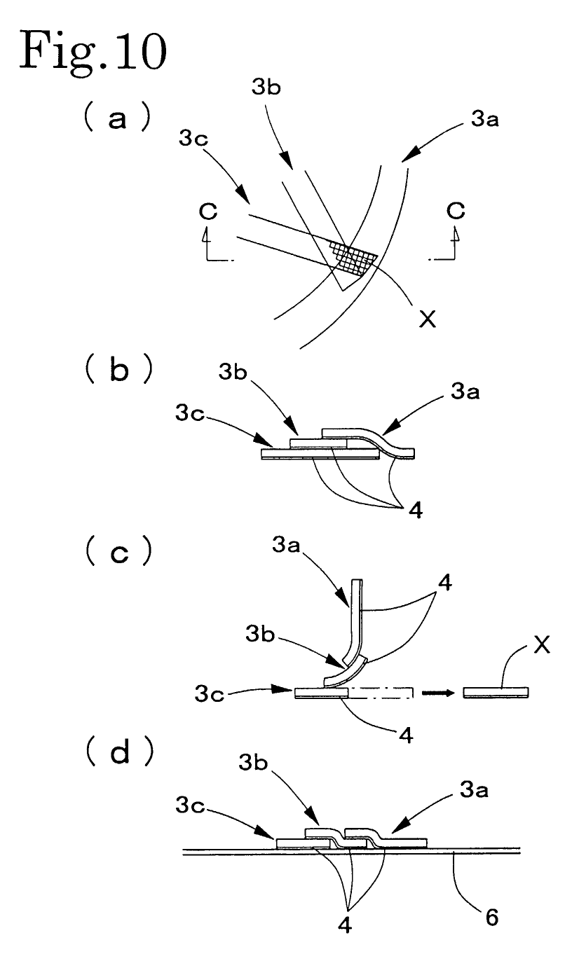

When each pattern of picture is combined, if the color of the color patching located underneath is deeper than that of the color patching located in the upper side at the overlapped part of color patching, the color of color patching located underneath is see-through and appears to the obverse side, moreover, the colors of the color patching are mixed, and the finish may be deteriorated, therefore it is desirable to cut off excessive cloth. In addition, since it may make the applique stiff when there are parts where three or more color patching are overlapped, as shown in FIG. 10(a), for example, it is also desirable to cut off excessive cloth from the reverse side of the pattern of picture to lessen the overlap of this color patching.

After combining and sticking by compression bonding each pattern of picture created separately, it is looked from the obverse side and excessive cloth is cut off. Excessive cloth is cut off from the reverse side of the pattern of picture which was removed from the temporary tack plate (1) as shown in FIG. 10(b) with scissors etc. By cutting off excessive cloth, although the appearance from the obverse side is the same as shown in FIG. 10(c), the unevenness at the reverse side of the applique is lost, and the applique will not come off easily because heat and pressure of the heating device is transferred approximately uniformly to the applique at the time of adhering to subject surfaces such as clothes, cloth and paper etc. Moreover, in the color patching which has a large color difference among the overlapped color patching, each color patching becomes vivid.

Then, it is put on the subject surface and stuck by thermo compression bonding until the whole parts are bonded completely at about 150 degree with the heating device, such as iron, and they are united, hence the applique relating to the present invention is created. This temporary tack tape (5) is removed in the middle of ironing before the pattern of picture is bonded completely.

Since the pattern of the applique relating to the present invention uses the color patching obtained by cutting in arbitrary form the color sheet which has an adhesive layer on the reverse side, it is possible to create favorite patterns by combining this color patching. For example, in case of using of strip-shaped color patching, the strip-shaped color patching can be placed with spacing to make a stripe shape, and also, lattice type and geometrical pattern can be made. In addition, by combining plurality of the color patching, these patterns can be arranged differently, and the image of whole applique may be changed and it is enjoyable.

Moreover, since the color patching used for the present invention becomes soft with heating, an arbitrary form can be made. Furthermore, even when a part may exfoliate by washing etc., the applique of the present invention can be re-stuck by thermo compression bonding with the heating device.

The applique relating to the present invention can be performed on clothes, such as T-shirt, trainer, and jeans, and cloth, such as pouches, and paper etc.

### EFFECTS OF THE INVENTION

As explained as above, the invention which relates to claim 1 is an applique attached on obverse side of cloth and paper etc., wherein after a process for creating plural color patching by cutting in arbitrary form a color sheet which has an adhesive layer on reverse side, subsequently, a transparent or translucent temporary tack plate is superposed on upper surface of an original drawing of picture, and a picture pattern is created by sticking the color patching to the obverse side of the temporary tack plate in accordance with the original drawing of picture, then the applique is obtained through a process which exfoliates the picture pattern from the obverse side of the temporary tack plate, and these processes for creating applique are repeated if necessary to create plural picture patterns, and the plural picture patterns are combined to obtain an applique, and the applique is carried out thermo compression bonding on the obverse side of cloth and paper etc., hence everyone can create easily an original applique by handmade.

The invention which relates to claim 2 is an applique described in claim 1 wherein in said process for creating a picture pattern, previously created picture pattern is arranged between said original drawing of picture and said temporary tack plate, and a following picture pattern is created according to said previously created picture pattern, hence no error in size is occurred, and excessive cloth does not run off at the superposed part when plurality of patterns of picture are superposed.

The invention which relates to claim 3 and 4 is an applique described in claim 1 and 2 wherein said color patching is strip-shaped, round and polygonal color patching, and in creating a picture pattern, a three-dimensional effect is brought by connecting, bending, disposing and overlapping said color patching, hence a three-dimensional effect to the finish is brought.

The invention which relates to claim 5 to 8 is an applique described either in claim 1 to 4 wherein said color patching is used more than two colors, hence it is possible to show uniqueness by crossing and disposing alternately the different colored color patching, and also possible to make an artistic, splendid, and new handiwork with a three-dimensional effect.

The invention which relates to claim 9 to 14 is an applique described either in claim 3 to 8 wherein the excessive cloth is cut off from the reverse side of the applique at the overlapped part of said color patching, hence the unevenness at the reverse side of the applique is lost, and the applique will not come off easily because heat and pressure of the heating device is transferred approximately uniformly to the applique at the time of adhering to subject surfaces such as clothes, cloth and paper etc.

What is claimed is:

1. An applique which is attached on obverse side of cloth and paper etc., wherein after a process for creating plural color patching by cutting in arbitrary form a color sheet which has an adhesive layer on reverse side, subsequently, a transparent or translucent temporary tack plate is superposed on upper surface of an original drawing of picture, and a picture pattern is created by sticking the color patching to an obverse side of the temporary tack plate in accordance with the original drawing of picture, then the applique is obtained through a process which exfoliates the picture pattern from the obverse side of the temporary tack plate, and these processes for creating applique are repeated if necessary to create plural picture patterns, and the plural picture patterns are combined to obtain an applique, and the applique is carried out thermo compression bonding on the obverse side of cloth and paper etc.

2. An applique described in claim 1, wherein in said process for creating a picture pattern, previously created picture pattern is arranged between said original drawing of picture and said temporary tack plate, and a following picture pattern is created according to said previously created picture pattern.

3. An applique described in claim 1, wherein said color patching is strip-shaped, round and polygonal color patching, and in creating a picture pattern, a three-dimensional effect is brought by connecting, bending, disposing and overlapping said color patching.

4. An applique described in claim 2, wherein said color patching is strip-shaped, round and in creating a picture pattern, polygonal color patching, and a three-dimensional effect is brought by connecting, bending, disposing and overlapping said color patching.

5. An applique described in claim 1, wherein said color patching is used more than two colors.

6. An applique described in claim 2, wherein said color patching is used more than two colors.

7. An applique described in claim 3, wherein said color patching is used more than two colors.

8. An applique described in claim 4 wherein said color patching is used more than two colors.

9. An applique described in claim 3 wherein excessive cloth is cut off from the reverse side of the applique at the overlapped part of said color patching.

10. An applique described in claim 4 wherein excessive cloth is cut off from the reverse side of the applique at the overlapped part of said color patching.

11. An applique described in claim 5 wherein the excessive cloth is cut off from the reverse side of the applique at the overlapped part of said color patching.

12. An applique described in claim 6 wherein the excessive cloth is cut off from the reverse side of the applique at the overlapped part of said color patching.

13. An applique described in claim 7 wherein the excessive cloth is cut off from the reverse side of the applique at the overlapped part of said color patching.

14. An applique described in claim 8 wherein the excessive cloth is cut off from the reverse side of the applique at the overlapped part of said color patching.
